(19) United States
(12) Patent Application Publication
(10) Pub. No.: US 2019/0086622 A1
(43) Pub. Date: Mar. 21, 2019

(54) METHOD FOR MANUFACTURING OPTICAL MODULE, APPARATUS FOR MANUFACTURING OPTICAL MODULE, AND OPTICAL MODULE

(71) Applicant: SUMITOMO ELECTRIC INDUSTRIES, LTD., Osaka (JP)

(72) Inventor: Takashi YAMADA, Osaka (JP)

(73) Assignee: SUMITOMO ELECTRIC INDUSTRIES, LTD., Osaka (JP)

(21) Appl. No.: 16/132,761

(22) Filed: Sep. 17, 2018

(30) Foreign Application Priority Data
Sep. 19, 2017 (JP) 2017-179354

(51) Int. Cl. G02B 6/42

(52) U.S. Cl. CPC G02B 6/4228; G02B 6/424; G02B 6/4274

(57) ABSTRACT

A method for manufacturing an optical module is disclosed. The method includes providing an optical coupling member and an optical device, arranging the optical coupling member and the optical device to face each other, and adjusting a position of at least one of the optical coupling member and the optical device. The optical coupling member includes a main body and a first electrode provided on a first face of the main body. The main body at least partially includes a transparent portion to visible light. The optical device includes a surface, a second electrode, and an optical region. The second electrode and the optical region are provided on the surface. The position is adjusted so that a positional relation between the first face and the surface is within a predetermined range, while recognizing at least part of the first face and the surface through the transparent portion from a second face opposite to the first face.

### CROSS-REFERENCE TO RELATED APPLICATION

The present application is based on and claims the benefit of priority of Japanese Patent Application No. 2017-179354, filed on Sep. 19, 2017, the entire content of which is incorporated herein by reference.

### TECHNICAL FIELD

The present disclosure relates to a method for manufacturing an optical module, an apparatus for manufacturing an optical module, and an optical module.

### BACKGROUND

Japanese Unexamined Patent Publication No. JP2007-094153 discloses an optical module having a structure in which an optical semiconductor device and an optical fiber face each other. The optical module mounts the optical semiconductor device on a retaining member in such a way that a light-receiving/emitting device faces the opening of a retaining hole of the retaining member. Thereby, the optical semiconductor device optically couples to the optical fiber inserted into the retaining hole.

### SUMMARY

The present disclosure provides a method for manufacturing an optical module. The method comprises steps of: (a) providing an optical coupling member comprising a main body and a first electrode provided on a first face of the main body, wherein the main body at least partially includes a transparent portion to visible light; (b) providing an optical device comprising a surface, a second electrode, and an optical region having at least one of a light-emitting region and a light-receiving region, wherein the second electrode and the optical region are provided on the surface; (c) arranging the optical coupling member and the optical device so as to face the first face and the surface with each other; (d) adjusting a position of at least one of the optical coupling member and the optical device so that a positional relation between the first face and the surface is within a predetermined range, while recognizing at least part of the first face and the surface through the transparent portion from a second face opposite to the first face in the main body; and (e) joining the second electrode to the first electrode.

The present disclosure provides an apparatus for manufacturing an optical module. The apparatus comprises a first support mechanism, a second support mechanism, an image recognition device, an adjustment device, and a joining device. The first support mechanism supports an optical coupling member comprising a main body and a first electrode provided on a first face of the main body. The main body at least partially includes a transparent portion to visible light. The second support mechanism supports an optical device comprising a surface, a second electrode, and an optical region having at least one of a light-emitting region and a light-receiving region. The second electrode and the optical region are provided on the surface. The image recognition device recognizes the optical device through the transparent portion of the main body from a second face thereof opposite to the first face. The adjustment device adjusts a position of at least one of the first support mechanism and the second support mechanism. The adjustment device adjusts the position of at least one of the optical coupling member and the optical device so that a positional relation of the optical device relative to the main body by the image recognition device is within a predetermined range. The joining device joins the second electrode to the first electrode.

The present disclosure provides an optical module which comprises an optical coupling member and an optical device. The optical coupling member comprises a main body and a first electrode provided on a first face of the main body. The main body provides therein a hole extending toward the first face from a second face opposite to the first face. The hole has a center axis intersecting the first face. The main body at least partially includes a transparent portion to visible light. The optical device comprises a surface, a second electrode, and an optical region including at least one of a light-emitting region and a light-receiving region. The second electrode and the optical region are provided on the surface. The second electrode is joined to the first electrode so that the surface faces the first face and the center axis of the hole is positioned at a center of the optical region.

### BRIEF DESCRIPTION OF THE DRAWINGS

The foregoing and other purposes, aspects and advantages will be better understood from the following detailed description of embodiments with reference to the drawings, in which:

FIG. 1 is a perspective view of an optical module according to an embodiment;

FIG. 2 is a perspective view of an optical coupling member of the optical module shown in FIG. 1;

FIG. 3 is a perspective view of an optical device of the optical module shown in FIG. 1;

FIG. 4 is a cross-sectional view showing a connection structure of the optical coupling member and the optical device in the optical module shown in FIG. 1;

FIG. 5 is a diagram showing one example of an apparatus for manufacturing an optical module;

FIG. 6 is a diagram schematically showing positional adjustment between the optical coupling member and the optical device;

FIG. 7 is a diagram showing details of individual members on a first face of the optical coupling member;

FIG. 8 is a diagram showing details of individual members on the surface of the optical device;

FIG. 9 is a diagram showing a case where a main body is recognized from a second face of the main body;

FIG. 10 is a diagram showing an optical coupling member according to a first modification;

FIG. 11 is a diagram showing an optical device according to the first modification;

FIG. 12 is a diagram showing a case where the main body is recognized from the second face of the main body of the optical coupling member shown in FIG. 10;

FIG. 13 is a diagram showing an optical coupling member according to a second modification;

FIG. 14 is a diagram showing an optical device according to the second modification;

FIG. 15 is a diagram showing a case where the main body is recognized from the second face of the main body of the optical coupling member shown in FIG. 13;

FIG. 16 is a diagram showing an optical coupling member according to a third modification;

FIG. 17 is a diagram showing an optical device according to the third modification;

FIG. 18 is a diagram showing a case where the main body is recognized from the second face of the main body of the optical coupling member shown in FIG. 16;

FIG. 19 is a diagram showing an optical coupling member according to a fourth modification;

FIG. 20 is a diagram showing an optical device according to the fourth modification;

FIG. 21 is a diagram showing a case where the main body is recognized from the second face of the main body of the optical coupling member shown in FIG. 19; and

FIG. 22 is a diagram showing a modification of the apparatus for manufacturing an optical module shown in FIG. 5.

### DETAILED DESCRIPTION

### Problems to be Solved by the Disclosure

In a conventional optical module, an optical semiconductor device can be attached to a retaining member, for example, through flip-chip bonding. It can be considered that in the occasion of this attachment, an optical mirror is arranged between the light-receiving/emitting face of the optical semiconductor device and the mounting face of the retaining member, images of both surfaces are recognized via this mirror by a camera, and based on the recognition results, the positions of the retaining member and the optical semiconductor device are adjusted. However, since arrangement accuracy of the mirror has its limit, mounting accuracy of the optical semiconductor device onto the retaining member has its limit with the method using the mirror. Meanwhile, in order to improve the mounting accuracy of the optical semiconductor device onto the retaining member without using a mirror, it can be considered, using infrared light, to acquire a transmission image of the light-receiving/emitting face and the mounting face, to recognize this transmission image by a camera, and to perform positional adjustment between both. However, an image recognition device using infrared light necessitates a large and complex facility.

### Effects of the Disclosure

The present disclosure can provide an optical module in which mounting accuracy is improved by simple means, a method for manufacturing the optical module and an apparatus for manufacturing the optical module.

### Description of Embodiments

Embodiments of the disclosure are listed and described. A method for manufacturing an optical module according to one embodiment comprises steps of: (a) providing an optical coupling member comprising a main body and a first electrode provided on a first face of the main body, wherein the main body at least partially includes a transparent portion to visible light; (b) providing an optical device comprising a surface, a second electrode, and an optical region having at least one of a light-emitting region and a light-receiving region, wherein the second electrode and the optical region are provided on the surface; (c) arranging the optical coupling member and the optical device so as to face the first face and the surface with each other; (d) adjusting a position of at least one of the optical coupling member and the optical device so that a positional relation between the first face and the surface is within a predetermined range, while recognizing at least part of the first face and the surface through the transparent portion from a second face opposite to the first face in the main body; and (e) joining the second electrode to the first electrode.

Since the main body includes the transparent portion to visible light in the above method, the part of the first face and the surface can be recognized via the transparent portion from the second face, and the position of the optical coupling member and/or the optical device can be adjusted in such a way that the positional relation between the first face and the surface is within a predetermined range. In this embodiment, positional adjustment is not performed by arranging a mirror between the optical coupling member and the optical device and acquiring surface images of both, but a positional relation between the optical coupling member and the optical device can be recognized to improve positional accuracy between both and to significantly improve mounting accuracy of the optical device relative to the optical coupling member. Besides, this method does not necessitate addition of an expensive and complex device such as an infrared one, but the apparatus can be suppressed from being upsized or made complex. Thus, this manufacturing method can improve mounting accuracy of the optical device relative to the optical coupling member by simple means. Furthermore, since the mounting accuracy can be significantly improved, this manufacturing method can reduce coupling loss due to optical axis deviation between the optical device (light-emitting region) and the optical coupling member, and thereby, can easily produce an optical module suitable for ultra high-speed transmission. Notably, “transparent to visible light” stated here means that the total light transmittance of visible light (for example, light with 480 nm to 670 nm of wavelength) through 1 mm of thickness is 60% or more, and it can be measured, for example, in conformity with JIS K 7361-1.

In the above method, the position of at least one of the optical coupling member and the optical device may be adjusted so that the first electrode and the second electrode are in a predetermined positional relation. Since the first electrode in the optical coupling member and the second electrode in the optical device are positioned with their optical centers (for example, of optical transmission) being as their references, by adjustment in such a way that the first electrode and the second electrode are in a predetermined positional relation, the manufacturing method according to this embodiment can perform adjustment in such a way that the positional relation between the optical coupling member and the optical device is within the predetermined range. Besides, since electrodes are easily recognized in general, the manufacturing method according to this embodiment can easily perform image recognition of the positions of the electrodes. Accordingly, the manufacturing method according to this embodiment improves mounting accuracy of the optical device relative to the optical coupling member by a simple technique.

In the above method, the position of at least one of the optical coupling member and the optical device may be adjusted so that an outer edge of the first electrode is positioned inward of an outer edge of the second electrode in the case of recognizing the main body from the second face. Since the manufacturing method according to this embodiment performs positional adjustment by the outer edge of the first electrode recognized on the proximal side being positioned within the outer edge of the second electrode recognized on the distal side, image recognition of the electrodes can be easily performed. Thus, the adjustment can be more securely performed in such a way that the first electrode and the second electrode are in the predetermined positional relation.

In the above method, the optical coupling member may comprise a first marker or a first dummy electrode provided on the first face, and the optical device may comprise a second marker or a second dummy electrode provided on the surface. The position of at least one of the optical coupling member and the optical device may be adjusted so that the first marker and the second marker are in a predetermined positional relation or so that the first dummy electrode and the second dummy electrode are in a predetermined positional relation, in the case of recognizing the main body from the second face. The manufacturing method according to this embodiment performs adjustment in such a way that the positional relation between the optical coupling member and the optical device is within the predetermined range by performing adjustment in such a way that the first marker and the second marker are in the predetermined positional relation or in such a way that the first dummy electrode and the second dummy electrode are in the predetermined positional relation. In this case, the shapes of the markers and the dummy electrodes can be set to be ones suitable for positioning or image recognition. Furthermore, as to the first marker or the second marker, the material (including its color) thereof can also be set to be one suitable for the positioning or the image recognition. Accordingly to this embodiment, mounting accuracy of the optical device relative to the optical coupling member can be further improved by a simple technique.

In the above method, an outer edge of the first marker and an outer edge of the second marker may have similar shapes to each other. The position of at least one of the optical coupling member and the optical device may be adjusted so that the outer edge of the first marker is positioned inward of the outer edge of the second marker while recognizing the main body from the second face. The manufacturing method according to this embodiment can perform adjustment in such a way that the first marker and the second marker are more securely in the predetermined positional relation.

In the above method, the first electrode or the first marker may be provided so as to protrude or to be recessed from the first face of, and the second electrode or the second marker may be provided so as to protrude or to be recessed from the surface. When the first electrode or the first marker is provided in such a way as to protrude from the first face, and the second electrode or the second marker is provided in such a way as to protrude from the surface, the first electrode or the first marker, and the second electrode or the second marker can be easily provided. Meanwhile, in the case where the first electrode or the first marker is provided in such a way as to be recessed from the first face, and the second electrode or the second marker is provided in such a way as to be recessed from the surface, when the positional relation between the optical coupling member and the optical device is adjusted, the first electrode and the second electrode, or the first marker and the second marker can be suppressed from interfering (coming into contact) with each other, and more secure positional adjustment can be performed.

In the above method, the position of at least one of the optical coupling member and the optical device may be adjusted so that a shortest clearance between the optical coupling member and the optical device is 10 μm or more and 1 mm or less. The manufacturing method according to this embodiment adjusts the positional relation between the optical coupling member and the optical device in the state where the clearance between both is short, and joins both together. Therefore, it reduces the amount of movement of at least one of the optical coupling member and the optical device in the occasion when the optical coupling member and the optical device are joined together. Thereby, the manufacturing method according to this embodiment reduces positional deviation due to movement of the member and the like, and further improves mounting accuracy of the optical device relative to the optical coupling member.

The above method may comprise a step of inserting an optical fiber into a through hole of the optical coupling member, wherein the through hole extends from the second face toward the first face and includes a center axis intersecting the first face. The manufacturing method according to this embodiment can easily manufacture an optical module including an optical fiber.

In the above method, the optical fiber may be inserted after adjusting the position, and the position of at least one of the optical coupling member and the optical device may be adjusted so that a center of the optical region coincides with the center axis of the through hole. By directly performing adjustment in such a way that the center of the optical region coincides with the center axis of the hole, the manufacturing method according to this embodiment more securely performs adjustment in such a way that the positional relation between the optical coupling member and the optical device is in the predetermined range. According to this embodiment, mounting accuracy of the optical device relative to the optical coupling member can be further improved by a simple technique.

In the above method, the main body may be substantially made of a transparent material to visible light. The main body may be made of quartz glass, transparent thermoplastic resins, or transparent thermosetting resins.

An apparatus for manufacturing an optical module according to an embodiment comprises a first support mechanism, a second support mechanism, an image recognition device, an adjustment device, and a joining device. The first support mechanism supports an optical coupling member comprising a main body and a first electrode provided on a first face of the main body. The main body at least partially includes a transparent portion to visible light. The second support mechanism supports an optical device comprising a surface, a second electrode, and an optical region having at least one of a light-emitting region and a light-receiving region. The second electrode and the optical region are provided on the surface. The image recognition device recognizes the optical device through the transparent portion of the main body from a second face thereof opposite to the first face. The adjustment device adjusts a position of at least one of the first support mechanism and the second support mechanism. The adjustment device adjusts the position of at least one of the optical coupling member and the optical device so that a positional relation of the optical device relative to the main body by the image recognition device is within a predetermined range. The joining device joins the second electrode to the first electrode.

The above apparatus recognizes the optical device via the main body from the second face opposite to the first face by the image recognition device. Therefore, this apparatus can easily improve mounting accuracy of the optical device relative to the optical coupling member as mentioned above.

An optical module according to one embodiment comprises an optical coupling member and an optical device. The optical coupling member comprises a main body and a first electrode provided on a first face of the main body. The main body provides therein a hole extending toward the first face from a second face opposite to the first face. The hole has a center axis intersecting the first face. The main body at least partially includes a transparent portion to visible light. The optical device comprises a surface, a second electrode, and an optical region including at least one of a light-emitting region and a light-receiving region. The second electrode and the optical region is provided on the surface. The second electrode is joined to the first electrode so that the surface faces the first face and the center axis of the hole is positioned at a center of the optical region.

In this optical module, the main body at least partially includes the transparent portion to visible light. Thus, the main body can be recognized from the second face, and a positional relation between the optical coupling member and the optical device can be easily adjusted. Thereby, it can be set to be an optical module in which mounting accuracy of the optical device relative to the optical coupling member is significantly improved. Moreover, since this optical module reduces coupling loss due to small optical axis deviation between the optical device and the optical coupling member, it can also be set to be an optical module suitable for ultra high-speed transmission.

In the above optical module, an outer edge of the second electrode may be larger than an outer edge of the first electrode. The optical module according to this embodiment more securely joins the second electrode to the first electrode.

### Details of Embodiments

Hereafter, an optical module, an apparatus for manufacturing an optical module and a method for manufacturing an optical module according to embodiments are described in detail with reference to the drawings. The present invention is not limited to these examples but intended to be indicated by the claims and to include all the modifications within the meaning and scope of equivalency of the claims. In the drawings, the same or corresponding portions are given the same signs, and their duplicated description is omitted.

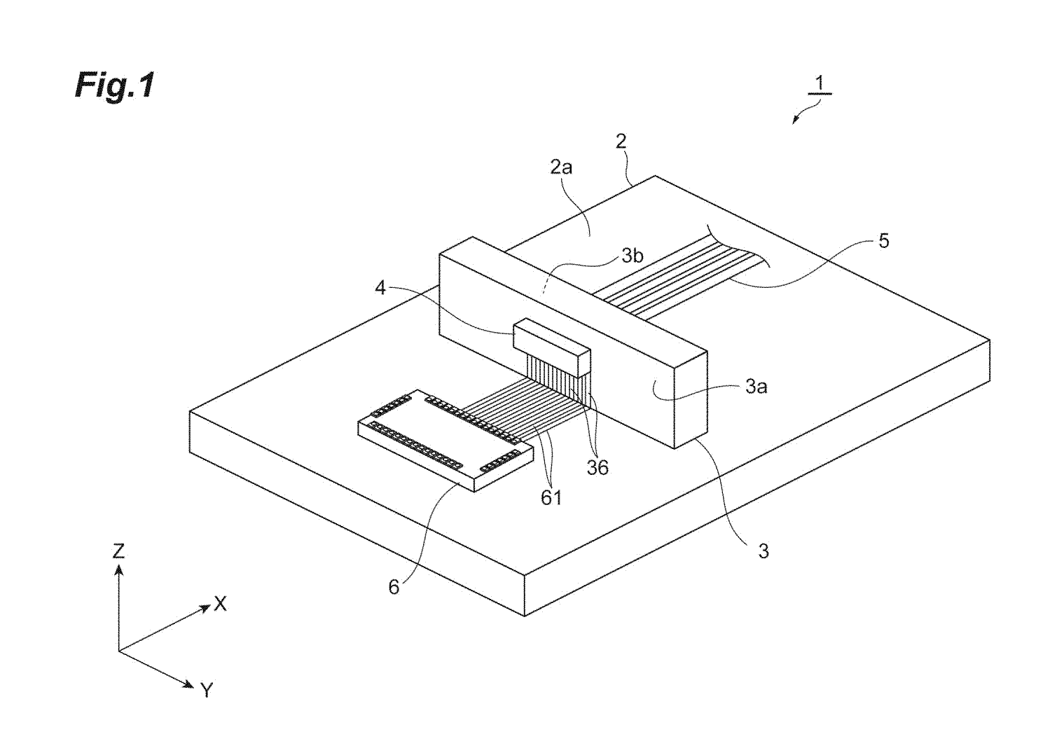

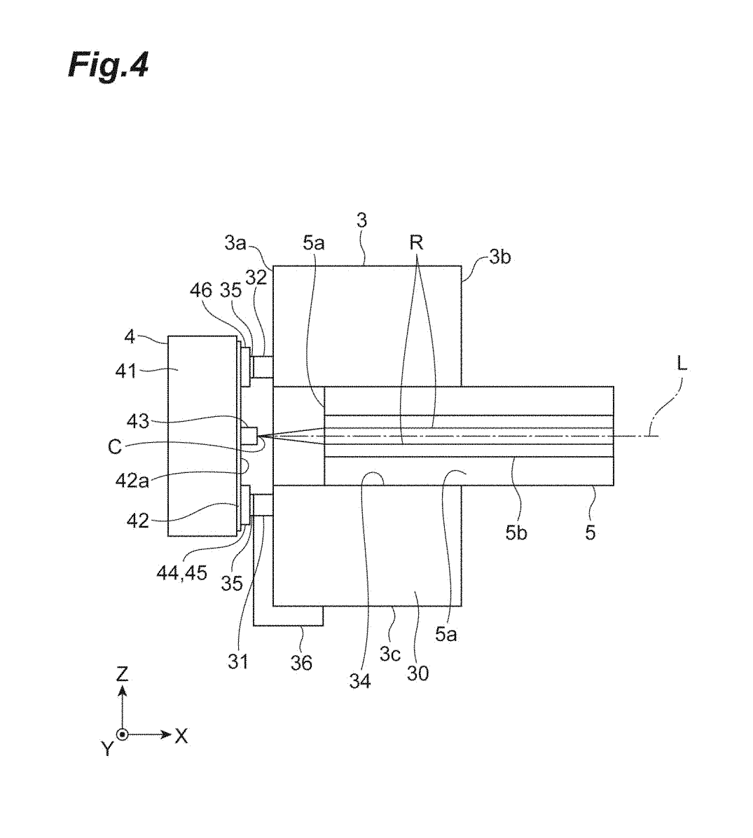

An optical module according to one embodiment is described. FIG. 1 is a perspective view of an optical module according to an embodiment. As shown in FIG. 1, the optical module 1 includes a circuit board 2, an optical coupling member 3, an optical device 4, optical fibers 5 and a drive circuit 6. The circuit board 2 has a principal surface 2a extending along the X-Y-plane, and on the principal surface 2a, the optical coupling member 3 and the drive circuit 6 are mounted. The optical device 4 is, for example, a light-emitting device such as a vertical cavity surface emitting laser (VCSEL), a light-receiving device such as a photo diode (PD), or a mix of both. The optical device 4 is mounted at the substantially center of a face 3a of the optical coupling member 3. The optical device 4 is electrically connected to the drive circuit 6 via electrodes 36 provided on the face 3a of the optical coupling member 3 and electrodes 61 provided on the principal surface 2a of the circuit board 2. The optical fibers 5 optically coupled to the optical device 4 with the optical coupling member 3 are individually inserted into holes 34 (see FIG. 4) provided in the optical coupling member 3, and their one ends are held therein.

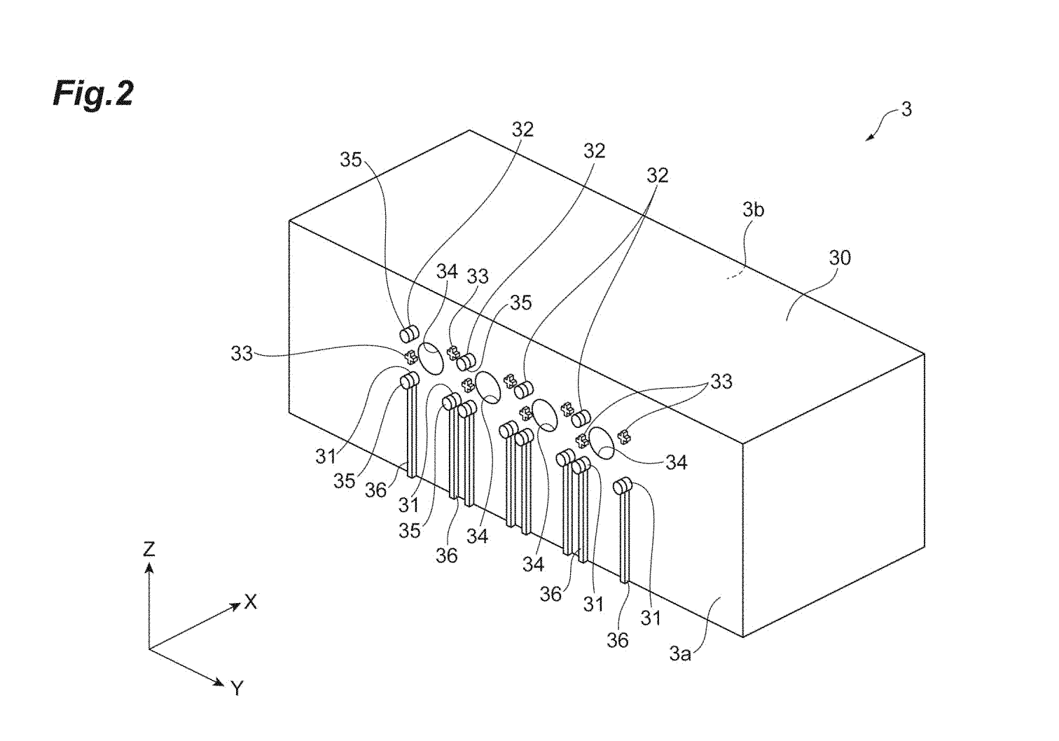

FIG. 2 is a perspective view of the optical coupling member 3. As shown in FIG. 2, a main body 30 of the optical coupling member 3 has a rectangular solid shape. The main body 30 is entirely made of a transparent material to visible light. The main body 30 can be formed, for example, from quartz glass, thermoplastic resins (polyacrylate-based resins (for example, U polymer (R)), cyclic olefin-based resins (for example, ARTON (R)), TERALINK (R) or the like), or thermosetting resins (epoxy ones, silicone ones or the like). In the main body 30 formed from the transparent material, for example, in the case of 1 mm of thickness, the total light transmittance to visible light with 480 to 670 nm of wavelength can be set to be 60% or more. Thereby, the mounting can be made while observing the positional relation between the optical coupling member 3 and the optical device 4 when the optical device 4 is mounted on the optical coupling member 3. The main body 30 may be made of a heat-resistant material, and, the main body 30 can also be made, for example, of the aforementioned transparent and heat-resistant resin. The optical coupling member 3 or the main body 30 having heat resistance can reduce the influence such as expansion or deformation due to heat in the occasion when the optical device 4 is mounted on the optical coupling member 3 and/or in the occasion when the optical coupling member 3 is mounted on the circuit board 2 through a reflowing process.

The optical coupling member 3 includes first electrodes 31, mechanical pads 32 each functioning as dummy electrodes, and first markers 33. The first electrodes 31, the mechanical pads 32, and the first markers 33 are provided on the first face 3a of the main body 30. The optical coupling member 3 further includes holes 34 therein. Each of the holes 34 extends from a second face 3b opposite to the first face 3a toward the first face 3a (see FIG. 4). As one example, the optical coupling member 3 includes four pair of the first electrodes 31, four mechanical pads 32, four pair of the first markers 33 and four holes 34. The numbers of the first electrodes 31, the mechanical pads 32, the first markers 33 and the holes 34 correspond to the number of light-receiving regions or light-emitting regions (hereinafter also expressed as “light-receiving/emitting regions” or “optical regions”) included in the optical device 4. As one example, the optical device 4 includes four light-emitting regions or light-receiving regions. A pair of first electrodes 31, one or two mechanical pad(s) 32, a pair of first markers 33 and one hole 34 may be provided for one light-receiving/emitting region. The main body 30 may be a minute member in which the distance (thickness) between the first and second faces 3a and 3b is less than 10 mm. The thickness of the main body 30 is 1 mm, for example.

The first electrode 31 has a disc shape, for example, having 30 μm to 70 μm of diameter, and protrudes from the first face 3a. The first electrodes 31 may be recessed from the first face 3a. The mechanical pad 32 has a disc shape, for example, having 30 μm to 70 μm of diameter, and protrudes from the first face 3a. The first markers 33 protrude from the first face 3a. The first marker 33 has a cross shape as seen from a direction intersecting the first face 3a, and its width is, for example, 20 μm to 70 μm. The first markers 33 may be recessed from the first face 3a.

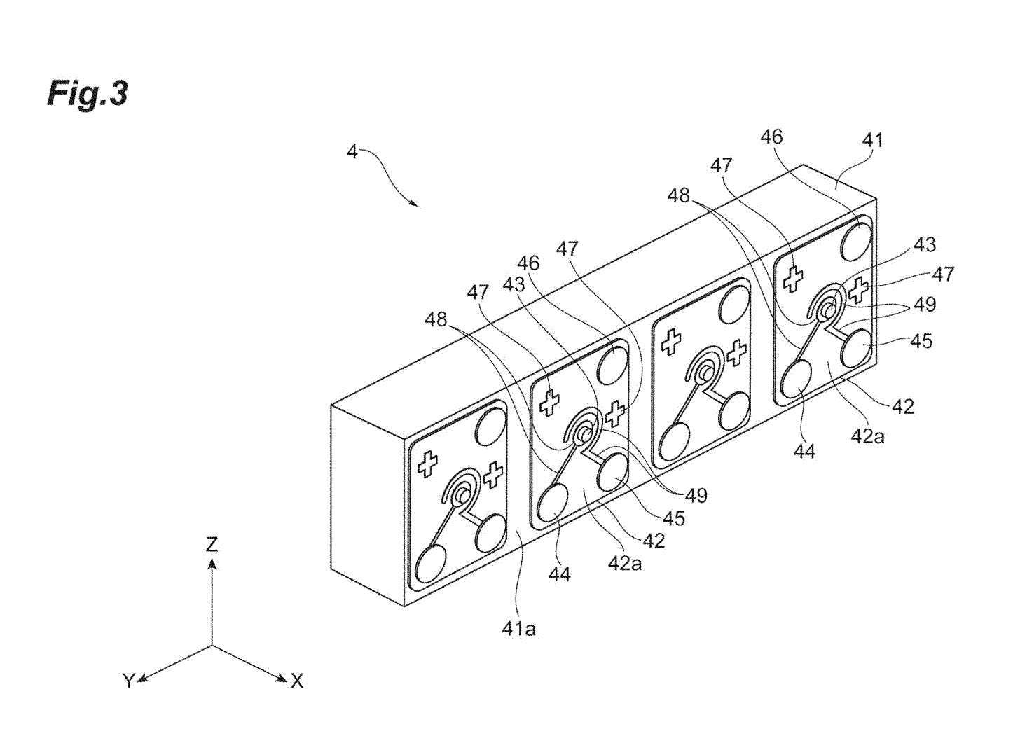

FIG. 3 is a perspective view of the optical device 4. As shown in FIG. 3, the optical device 4 is, for example, a VCSEL chip and includes a substrate 41 and channels 42. As one example, the optical device includes four channels 42. The channels 42 are arranged to line up on a surface 41a of the substrate 41 along the Y-axis direction. Center distances between the channels 42 in the Y-axis direction correspond to center distances between the holes 34 in the Y-axis direction. Each channel 42 has a surface 42a, and on the surface 42a, has a light-emitting region 43, an anode electrode 44, a cathode electrode 45, a mechanical pad 46 electrically insulated from other members and functioning as a dummy electrode, and second markers 47. The light-emitting region 43 and the electrode 44 are electrically connected to each other via an electrode 48. On the outer periphery of the light-emitting region 43, an electrode 49 electrically connected to the electrode 45 is provided. The numbers of the electrodes 44 and 45, the mechanical pads 46 and the second markers 47 correspond to the number of the light-receiving/emitting regions 43 (four light-emitting regions in the present embodiment). One electrode 44, one electrode 45, one or two mechanical pad(s) 46 and a pair of markers 47 are provided for one light-receiving/emitting region.

Each of the electrodes 44 and 45 has a disc shape, for example, having 50 μm to 90 μm of diameter, and protrudes from the surface 42a. The diameters of the electrodes 44 and 45 are larger than the diameter of the electrode 31 of the optical coupling member 3, and may be larger than the diameter of the electrode 31 by 20 μm at most. The electrodes 44 and 45 may be recessed from the surface 42a. The mechanical pad 46 has a disc shape, for example, having 50 μm to 90 μm of diameter, and protrudes from the surface 42a. The diameter of the mechanical pad 46 is larger than the diameter of the mechanical pad 32 of the optical coupling member 3, and may be larger than the diameter of the mechanical pad 32 by 20 μm at most. The second markers 47 protrude from the surface 42a. The second marker 47 has a cross shape as seen from a direction intersecting the surface 42a, and its width is, for example, 30 μm to 80 μm. The second markers 47 may be recessed from the surface 42a.

While in the above, the case of the optical device 4 in which the plurality of light-emitting regions 43 are formed and integrated onto the common substrate 41 is described, each light-emitting region 43 or light-receiving region 43 may be formed on an individual substrate. Moreover, while in the above, the case where the optical device 4 is a light-emitting device is described, the optical device 4 may be a light-receiving device such as a PD, or may be one in which a light-emitting device and a light-receiving device are mixed. Furthermore, the optical device 4 may be configured of a device only having one light-emitting region or one light-receiving region. Namely, the optical device 4 has, on the surface 42a, the optical region 43 which is at least one of the light-emitting region and the light-receiving region. In the optical device 4, when light-emitting devices and light-receiving devices are mixed, the light-emitting devices and the light-receiving devices may be formed on respective separate common substrates. When the optical device 4 is configured of a device only having one light-emitting region or one light-receiving region, one hole 34 and the like are to be provided in the optical coupling member 3.

Next, referring to FIG. 4, a connection structure of the optical coupling member 3 and the optical device 4 in the optical module 1 is described more in detail. FIG. 4 is a cross-sectional view showing the connection structure of the optical coupling member 3 and the optical device 4.

As shown in FIG. 4, the optical coupling member 3 includes the hole 34 and the optical fiber 5 inserted into the hole 34 at the substantially center inside the main body 30. The optical device 4 is mounted on the face 3a of the optical coupling member 3 in such a way that the surface 42a (light-receiving/emitting region 43) faces the hole 34. The electrodes 31 of the optical coupling member 3 and the electrodes 44 and 45 of the optical device 4 are joined together, for example, via AuSn solder layers 35. Moreover, the mechanical pad 32 of the optical coupling member 3 and the mechanical pad 46 of the optical device 4 are joined together, for example, via an AuSn solder layer 35. Such joining between these optical coupling member 3 and optical device 4 may be performed with Au or Cu bumps. While in FIG. 4, the hole 34 and the optical fiber 5 corresponding to one light-receiving/emitting region 43 or channel 42 in the optical device 4 are described, the configurations of the holes and the like corresponding to the other light-receiving/emitting regions 43 are also similar and their description is omitted here. The AuSn solder layers 35 may be beforehand formed on the electrodes 31 and the mechanical pads 32 of the optical coupling member 3 (see FIG. 2) to be joined to the electrodes 44 and 45 and the mechanical pads 46 of the optical device 4. Alternatively, the AuSn solder layers 35 may be beforehand formed on the electrodes 44 and 45 and the mechanical pads 46 of the optical device 4 to be joined to the electrodes 31 and the mechanical pads 32 of the optical coupling member 3.

In the main body 30, for example, four holes 34 are sequentially formed along the Y-axis direction (see FIG. 2). Each of the holes 34 is a through hole penetrating from the second face 3b to the first face 3a. The hole 34 has a center axis L perpendicular to (intersecting) the first face 3a. The diameter of the hole 34 is constant from the second face 3b to the first face 3a, and, for example, can be set to be 128 μm. On the lower side of the hole 34 on the first face 3a, an electrode 36 extending from the first electrode 31 to a lower face 3c along the Z-axis direction is provided. As shown in FIG. 2, the first electrodes 31 are arranged along the Y-axis direction. A pair of first electrodes 31 correspond to one hole 34. On the upper side of the hole 34 on the first face 3a, the mechanical pad 32 is provided. As shown in FIG. 2, the mechanical pads 32 are arranged along the Y-axis direction. One or two mechanical pads 32 correspond to a pair of first electrodes 31 and one hole 34.

As shown in FIG. 4, the optical device 4 is arranged in such a way as to face the optical coupling member 3. Specifically, the optical device 4 is provided in such a way that the surface 42a faces the first face 3a. The optical device 4 is mounted on the first face 3a in such a way that the individual channels 42 face the respective holes 34. By such mounting, the surfaces 42a face the respective holes 34. The channel 42 has the light-emitting region 43, and the optical axis of light emitted from the light-emitting region 43 is adjusted in such a way as to be positioned on the center axis L. The optical device 4 is provided in such a way that the center axis L of the hole 34 is positioned at a center C of the light-emitting region (optical region) 43. The electrodes 44 and 45 are joined to the respective first electrodes 31 via the AuSn solder layers 35, and furthermore, are connected to the drive circuit 6 via the electrodes 36 and the electrodes 61 shown in FIG. 1. The mechanical pad 46 is joined to the mechanical pad 32 via the AuSn solder layer 35, and the optical device 4 is mounted in such a way as to be parallel to the first face 3a.

The optical fiber 5 is inserted into the hole 34. The optical fiber 5 is inserted into the hole 34 in such a way that its tip 5a is positioned between the first face 3a and the second face 3b. The outer diameter of the optical fiber 5 is, for example, 125 μm and an outer diameter substantially equivalent to (slightly smaller than) the diameter of the hole 34. Thereby, the optical axis of the optical fiber 5 can easily coincide with the center C of the light-emitting region 43. The optical fiber 5 may have a configuration in which it is inserted into the hole 34 using a ferrule.

Here, FIG. 1 is referred to again. In the optical module 1 having the aforementioned configuration, the drive circuit 6 configured, for example, of an integrated circuit (IC) is electrically connected to the optical device 4 via the electrodes 36, the electrodes 61, the electrodes 31 and the electrodes 44 and 45. Light reception/emission of the optical device 4 is controlled by an electric signal from the drive circuit 6. When the optical device 4 is a light-emitting device, in the optical module 1, light from the optical device 4 is caused to enter the optical fiber 5. More specifically, as shown in FIG. 4, when a drive signal is input to the optical device 4 by the drive circuit via the electrodes and the like, light emission by the channel 42 of the optical device 4 is performed, and the light R is caused to enter a core 5b of the optical fiber 5. On the other hand, when the optical device 4 is a light-receiving device, the light R propagating through the optical fiber 5 is caused to enter the optical device 4 which is the light-receiving device. The light entering the optical device 4 is photoelectrically converted at the optical device 4, and an electric signal is output to the drive circuit 6. Since in the optical module 1, the optical device 4 and the drive circuit 6 are connected to each other via the electrodes 61 and the like on the circuit board 2 and there is no configuration of providing bonding wires between the optical device 4 and the drive circuit 6, the height of the device is made low.

Effects and operation obtained by the optical module 1 are described. In the optical module 1, the main body 30 is wholly or partially made of the transparent material to visible light. In this case, the first face 3a of the main body 30 can be recognized from the second face 3b via the transparent portion, and a positional relation between the optical coupling member 3 and the optical device 4 can be adjusted by observing each surface via the transparent portion. Therefore, the optical module 1 with the above configuration can simply improve mounting accuracy between the optical coupling member 3 and the optical device 4.

In the optical module 1, outer edges 44a and 45a of the second electrodes 44 and 45 are larger than outer edges 31a of the first electrodes 31. Therefore, the second electrodes 44 and 45 can be more securely joined to the first electrodes 31.

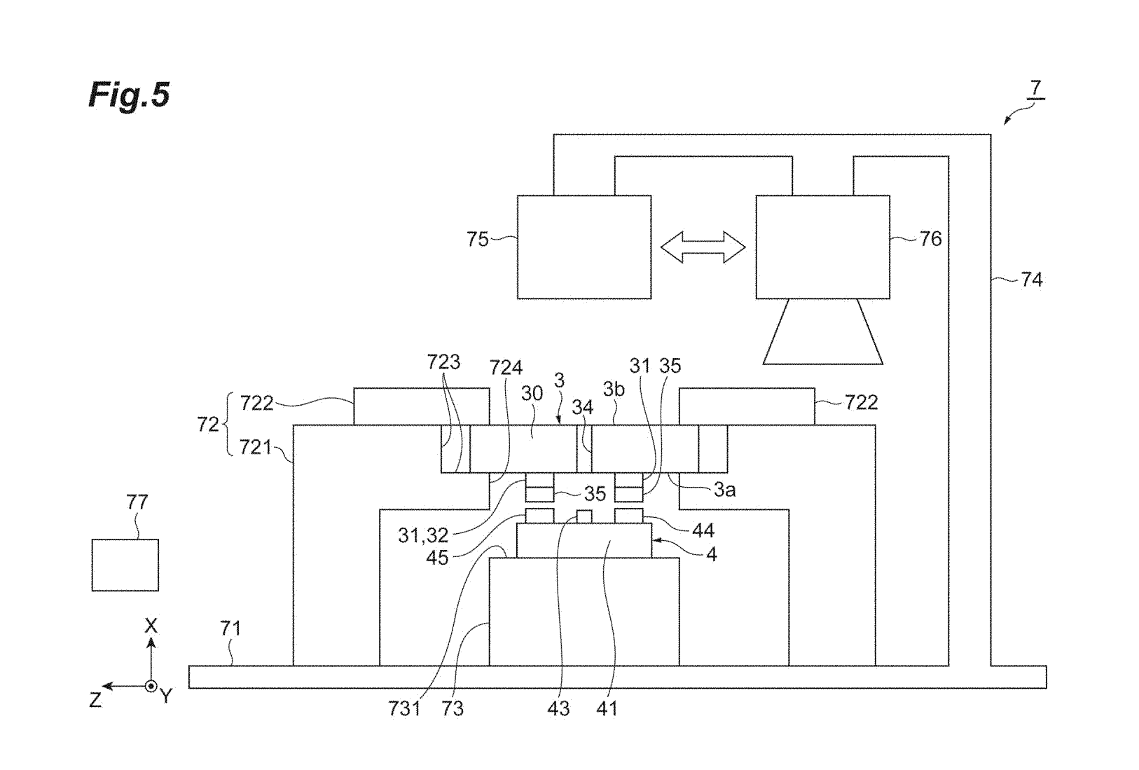

Next, an apparatus for manufacturing the optical module 1 is described. FIG. 5 is a diagram showing a manufacturing apparatus 7 of the optical module 1. As shown in FIG. 5, the manufacturing apparatus 7 includes a base 71, a first support mechanism 72, a second support mechanism 73, a hanging member 74, an image recognition device 75, a joining device 76 and an adjustment device 77. The base 71 is disposed, for example, on the ground. The first support mechanism 72, the second support mechanism 73, the hanging member 74, the image recognition device 75, the joining device 76 and the adjustment device 77 are arranged on the base 71.

The first support mechanism 72 supports the optical coupling member 3. The first support mechanism 72 has a placement table 721 and clamps 722. The placement table 721 is disposed on the base 71. The placement table 721 is formed so as to contain the second support mechanism 73 and the optical device 4 therein. A groove 723 is formed in the placement table 721, and the groove 723 places the optical coupling member 3. The depth of the groove 723 is comparable, for example, to the thickness of the main body 30 of the optical coupling member 3. The groove 723 is formed in such a way that its width is larger than the width of the optical coupling member 3 such that the optical coupling member 3 can be placed thereon. A through hole 724 is formed in the groove 723. The through hole 724 is formed in such a way that its width is smaller than the width of the optical coupling member 3 such that the optical coupling member 3 can be placed on the groove 723. The width of the through hole 724 is smaller than the width of the optical coupling member 3. The groove 723 places the optical coupling member 3 in such a way that the first face 3a faces the through hole 724.

The clamps 722 are respectively arranged on both sides of the groove 723. The clamps 722 clamp the optical coupling member 3 placed in the groove 723. The placement table 721 and the clamps 722 support the optical coupling member 3 in such a way that the first face 3a and the second face 3b are almost exposed.

The second support mechanism 73 supports the optical device 4. The second support mechanism 73 is disposed on the base 71 in such a way that a support surface 731 faces the through hole 724. The support surface 731 of the second support mechanism 73 places the optical device 4 thereon. The optical device 4 is placed on the support surface 731 in such a way that the surface 42a (see FIG. 4) faces the through hole 724 and the first face 3a. The second support mechanism 73 has a moving mechanism which moves the second support mechanism 73 with respect to the first support mechanism 72. The second support mechanism 73 can be moved along the surface of the base 71 (first face 3a) by the above moving mechanism. In the state of being supported on the second support mechanism 73, the optical device 4 can be moved along the surface of the base 71 along with the second support mechanism 73. The second support mechanism 73 can be moved along a direction intersecting the surface of the base 71. In the state of being supported on the second support mechanism 73, the optical device 4 can be caused to come close to and to go apart from the optical coupling member 3 along with the second support mechanism 73.

The hanging member 74 supports the image recognition device 75 and the joining device 76. The hanging member 74 is disposed on the base 71. The height of the hanging member 74 is higher than both of the sum of the heights of the first support mechanism 72 and the image recognition device 75 and the sum of the heights of the first support mechanism 72 and the joining device 76.

The image recognition device 75 is configured so as to recognize the optical device 4 via the main body 30 (transparent portion) from the second face 3b. The image recognition device 75 includes a microscope and a camera. The microscope is, for example, an optical microscope. The camera is, for example, a charge coupled device (CCD) camera. The hanging member 74 supports the image recognition device 75 in such a way as that the image recognition device 75 faces the first support mechanism 72 and the second support mechanism 73. The image recognition device 75 transmits an image of the optical coupling member 3 (first face 3a) and the optical device 4 (surface 41a) to a display, the image acquired by the microscope and the camera. The image recognition device 75 may have an image processor which processes the image acquired by the microscope and the camera. The image recognition device 75 can be moved along the surface of the base 71.

The joining device 76 is a device for joining the first electrodes 31 of the optical coupling member 3 and the second electrodes 44 and 45 of the optical device 4 together. The joining device 76 has, for example, an infrared heater. The joining device 76 irradiates the AuSn solder layers 35 between the first electrodes 31 and the second electrodes 44 and 45 with infrared light, and thereby, melts the AuSn solder layers 35 to join the first electrodes 31 and the second electrodes 44 and 45 together. The joining device 76 joins the mechanical pad 32 and the mechanical pad 46 together by melting the AuSn solder layers 35. The joining device 76 can be moved along the surface of the base 71.

The adjustment device 77 has, for example, a controller, and adjusts the position of the second support mechanism 73. The adjustment device 77 is electrically connected to the moving mechanism of the second support mechanism 73. The adjustment device 77 adjusts the position of the second support mechanism 73 by controlling the moving mechanism of the second support mechanism 73. Thereby, the adjustment device 77 adjusts the position of the optical device 4 placed on the second support mechanism 73 in such a way that a positional relation of the optical device 4 relative to the main body 30 by the image recognition device 75 is within a predetermined range. In FIG. 5, the first markers 33 of the optical coupling member 3, and the channel 42 and the second markers 47 of the optical device 4 are omitted.

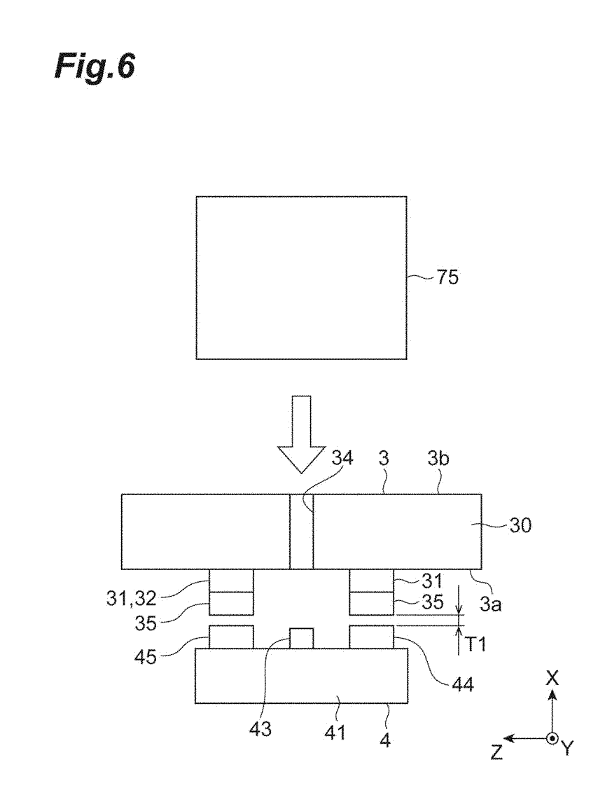

FIG. 6 is a diagram schematically showing positional adjustment between the optical coupling member 3 and the optical device 4. As shown in FIG. 6, while the optical device 4 is being recognized via the main body 30 from the second face 3b of the optical coupling member 3 by the image recognition device 75, its position is adjusted. The position between the optical coupling member 3 and the optical device 4 can be adjusted in the state where the shortest distance between these, that is, a distance T1 between the AuSn solder layers 35 and the electrodes 44 and 45 and the mechanical pad 46 is, for example, 10 μm or more and 1 mm or less.

In the manufacturing apparatus 7, when the optical coupling member 3 and the optical device 4 are placed on the first support mechanism 72 and the second support mechanism 73, respectively, the adjustment device 77 controls the moving mechanism of the second support mechanism 73 on the basis of recognition of the image recognition device 75, and adjusts the position of the optical device 4 supported by the second support mechanism 73. The adjustment device 77 controls the moving mechanism of the second support mechanism 73, and causes the optical device 4 to come close to the optical coupling member 3. When the optical device 4 comes into contact with the optical coupling member 3, the positions of the image recognition device 75 and the joining device 76 are exchanged. The joining device 76 irradiates the AuSn solder layers 35 which are joint parts between the optical device 4 and the optical coupling member 3 with infrared light, and melts the AuSn solder layers 35. After the AuSn solder layers 35 harden, the optical device 4 and the optical coupling member 3 are joined together.

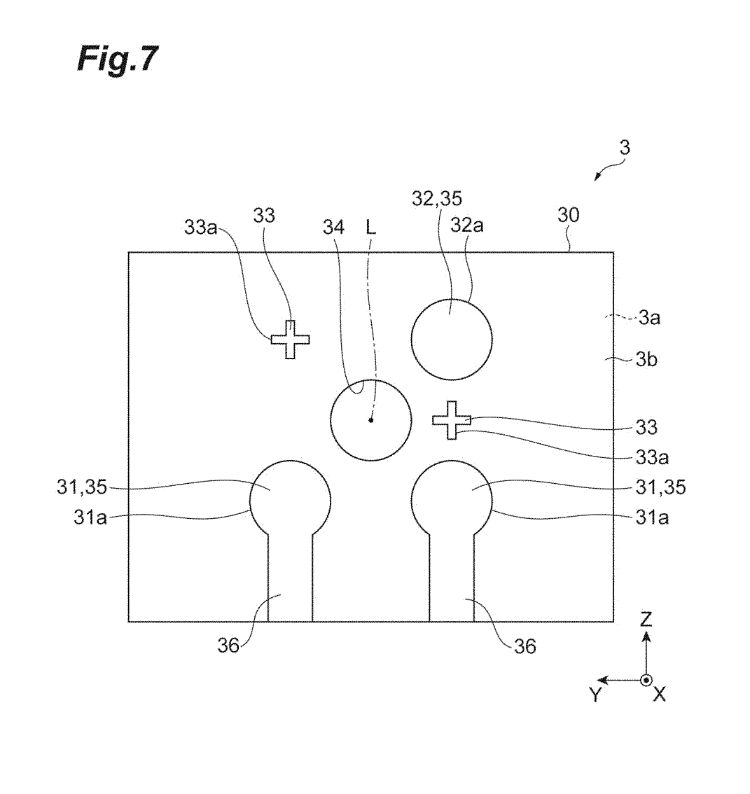

Next, a method for manufacturing the optical module 1 using the manufacturing apparatus 7 is described. First, the configurations of the optical coupling member 3 and the optical device 4 are described more in detail. FIG. 7 is a diagram showing details of the individual members on the first face 3a of the optical coupling member 3. FIG. 7 is a diagram of the face 3a as seen from the second face 3b. While in FIG. 7, the individual members corresponding to one hole 34 are described, member configurations corresponding to the other holes 34 are also similar, and their description is herein omitted. As shown in FIG. 7, the hole 34 is provided at the approximate center of the main body 30 in the Z-axis direction. The first electrodes 31 are provided nearer the circuit board 2 (see FIG. 1) in relation to the hole 34. The hole 34 is interposed between the first electrodes 31 in the Y-axis direction. Each of the first electrode 31 is provided at a predetermined position relative to the hole 34. Specifically, each of the first electrode 31 is provided in such a way that its center is at a predetermined position relative to the center axis L of the hole 34. The first electrodes 31 have the outer edges 31a. The electrode 36 is provided adjacent to the circuit board 2. The electrode 36 is electrically connected to each first electrode 31. The diameter of the first electrodes 31 is, for example, 60 μm.

The mechanical pad 32 is provided opposite to the circuit board 2 relative to the hole 34. The mechanical pad 32 is provided on one side relative to the hole 34 in the Y-axis direction. The mechanical pad 32 is provided at a predetermined position relative to the hole 34. Specifically, the mechanical pad 32 is provided in such a way that its center is at a predetermined position relative to the center axis L of the hole 34. The mechanical pad 32 has an outer edge 32a. The diameter of the mechanical pad 32 is, for example, 60 μm.

One of the first markers 33 is provided between the mechanical pad 32 and the first electrode 31 in the Z-axis direction, and the other of the first markers 33 is provided opposite to the mechanical pad 32 relative to the hole 34 in the Y-axis direction. Each of the first marker 33 is provided at a predetermined position relative to the hole 34. Specifically, the first marker 33 is provided in such a way that its center is at a predetermined position relative to the center axis L of the hole 34. The first markers 33 have outer edges 33a.

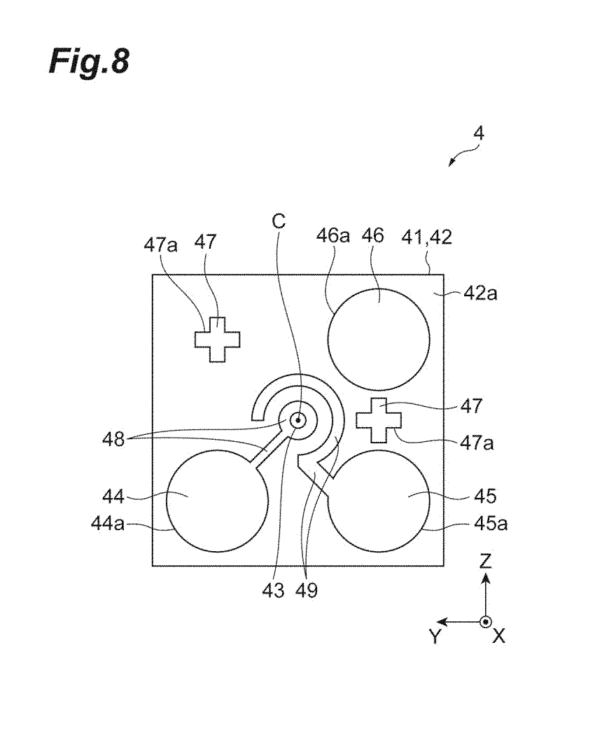

FIG. 8 is a diagram showing details of the individual members on the surface 42a of the optical device 4. FIG. 8 is a diagram of the optical device 4 in the case as seen from the surface 42a. While in FIG. 8, the individual members corresponding to one channel 42 are described, member configurations corresponding to the other channels 42 are also similar, and their description is herein omitted. As shown in FIG. 8, the light-emitting region 43 is provided at the approximate center of the channel 42 in the Z-axis direction. The electrodes 44 and 45 are provided nearer the circuit board 2 (see FIG. 1) in relation to the light-emitting region 43. The light-emitting region 43 is interposed between the electrodes 44 and 45 in the Y-axis direction. Each of the electrodes 44 and 45 is provided at a predetermined position relative to the light-emitting region 43. Specifically, each of the electrodes 44 and 45 is provided in such a way that its center is at a predetermined position relative to the center C of the light-emitting region 43. The electrodes 44 and 45 have outer edges 44a and 45a, respectively. The diameter of the electrodes 44 and 45 is, for example, 70 μm.

The mechanical pad 46 is provided opposite to the circuit board 2 relative to the light-emitting region 43. The mechanical pad 46 is provided on one side relative to the light-emitting region 43 in the Y-axis direction. The mechanical pad 46 is provided at a predetermined position relative to the light-emitting region 43. Specifically, the mechanical pad 46 is provided in such a way that its center is at a predetermined position relative to the center C of the light-emitting region 43. The mechanical pad 46 has an outer edge 46a. The diameter of the mechanical pad 46 is, for example, 70 μm.

One of the second markers 47 is provided between the mechanical pad 46 and the electrode 45 in the Z-axis direction, and the other of the second marker 47 is provided on the opposite side to the mechanical pad 46 relative to the light-emitting region 43 in the Y-axis direction. Each of the second markers 47 is provided at a predetermined position relative to the light-emitting region 43. Specifically, each second marker 47 is provided in such a way that its center is at a predetermined position relative to the center C of the light-emitting region 43. The second markers 47 have outer edges 47a. The outer edge 33a of the first marker 33 and the outer edge 47a of the second marker 47 have similar shapes to each other.

The manufacturing method of the optical module 1 includes a first step, a second step, a third step, a fourth step and a fifth step.

In the manufacturing method of the optical module 1, in the first step, the optical coupling member 3 is provided. In the second step, the optical device 4 is provided. Subsequently, in the third step, the optical coupling member 3 and the optical device 4 are arranged in such a way that the first face 3a of the optical coupling member 3 and the surface 42a of the optical device 4 face each other (see FIG. 5). Specifically, the optical coupling member 3 is placed on the first support mechanism 72 in such a way that the first face 3a faces the through hole 724, and the optical device 4 is placed on the second support mechanism 73 in such a way that the surface 42a faces the through hole 724. Subsequently, in the fourth step, the main body 30 is recognized from the second face 3b (see FIG. 6), and the position of the optical device 4 is adjusted in such a way that a positional relation between the optical coupling member 3 and the optical device 4 is within a predetermined error range.

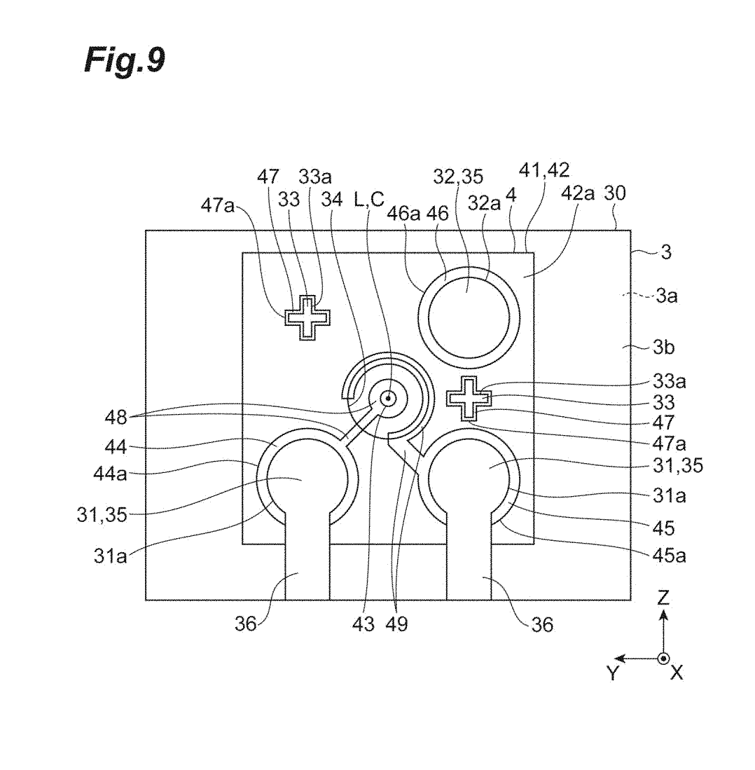

FIG. 9 is a diagram showing a case where the main body 30 is recognized from the second face 3b in the fourth step. As shown in FIG. 9, in the fourth step, the position of the optical device 4 is adjusted in such a way that the electrodes 31 and the electrodes 44 and 45 are in predetermined positional relations. Specifically, the position of the optical device 4 is adjusted in such a way that the individual outer edges 31a of the electrodes 31 are positioned in the individual outer edges 44a and 45a of the electrodes 44 and 45, and the distances between the outer edges 31a and the outer edges 44a and 45a are approximately uniform in the periphery of the outer edges 31a when the main body 30 is recognized from the second face 3b. Further specifically, the position of the optical device 4 is adjusted in such a way that the distances between the outer edges 31a and the outer edges 44a and 45a are approximately 5 μm.

In the fourth step, the position of the optical device 4 may be adjusted in such a way that the center C of the light-emitting region 43 coincides with the center axis L of the hole 34. In the fourth step, the position of the optical device 4 may be adjusted in such a way that the mechanical pad 32 and the mechanical pad 46 are in the predetermined positional relation as mentioned above when the main body 30 is recognized from the second face 3b. Specifically, the position of the optical device 4 may be adjusted in such a way that the outer edge 32a of the mechanical pad 32 is positioned within the outer edge 46a of the mechanical pad 46, and the distance between the outer edge 32a and the outer edge 46a is approximately uniform in the periphery of the outer edge 32a when the main body 30 is recognized from the second face 3b. Further specifically, the position of the optical device 4 may be adjusted in such a way that the distance between the outer edge 32a and the outer edge 46a is approximately 5 μm.

In the fourth step, furthermore, the position of the optical device 4 may be adjusted in such a way that the first marker 33 and the second marker 47 are in a predetermined positional relation when the main body 30 is recognized from the second face 3b. Specifically, the main body 30 is recognized from the second face 3b, and the position of the optical device 4 may be adjusted in such a way that the outer edge 33a of the first marker 33 is located within the outer edge 47a of the second marker 47. In the aforementioned positional adjustment, any of the electrodes and the markers may be used solely or in combination.

Subsequently, after the fourth step, in the fifth step, the electrodes 31 of the optical coupling member 3 and the electrodes 44 and 45 of the optical device 4 are joined to each other, respectively. Specifically, after the positional adjustment between the optical coupling member 3 and the optical device 4 is completed, the optical device 4 is moved toward the through hole 724, and the optical coupling member 3 and the optical device 4 are caused to come close to each other. The optical coupling member 3 and the optical device 4 are caused to come close to each other until the electrodes 44 and 45 come into contact with the AuSn solder layers 35 formed on the electrodes 31, respectively, and the mechanical pad 46 comes into contact with the AuSn solder layer 35 formed on the mechanical pad 32. Subsequently, the positions of the image recognition device 75 and the joining device 76 are exchanged (see FIG. 5). Subsequently, the AuSn solder layers 35 are irradiated with infrared light from the joining device 76, and the AuSn solder layers 35 are melted. After the molten AuSn solder layers 35 harden, the electrodes 31 and the electrodes 44 and 45 are joined together, respectively, and the mechanical pad 32 and the mechanical pad 46 are joined together. Subsequently, the optical fibers 5 are inserted into the holes 34.

Effects and operation obtained by the manufacturing method of the optical module 1 described above are described. In the manufacturing method of the optical module 1, the main body 30 is recognized from the second face 3b opposite to the first face 3a, the first face 3a and the surface 42a are recognized via a transparent portion of the main body 30, and the position of the optical device 4 relative to the optical coupling member 3 is adjusted. Since the main body 30 is formed from the transparent material to visible light, it is not needed to recognize, via a mirror as conventional one, the positional relation between both surfaces of the optical coupling member 3 and the optical device 4. Since mounting accuracy between the optical coupling member 3 and the optical device 4 is not restricted by arrangement accuracy of the mirror in this manufacturing method, the mounting accuracy (predetermined error range) of the optical device 4 relative to the optical coupling member 3 can be set to be 3 μm or less.

According to this manufacturing method, since mounting accuracy can be significantly improved, coupling loss due to small optical axis deviation between the optical device 4 (light-emitting region) and the optical coupling member 3 can be reduced. Thereby, an optical module suitable for ultra high-speed transmission can be easily produced by this manufacturing method. Besides, this manufacturing method does not need to add another device and can prevent from upsizing the facility or making the facility complex. Thus, this manufacturing method can improve the mounting accuracy between the optical coupling member 3 and the optical device 4 by simple means. “Transparent to visible light” stated here means that the total light transmittance of visible light (for example, light with 480 nm to 670 nm of wavelength) through 1 mm of thickness is 60% or more, and it can be measured, for example, in conformity with MS K 7361-1.

In the manufacturing method, the position of the optical device 4 is adjusted in such a way that the electrodes 31 and the electrodes 44 and 45 are in predetermined positional relations, respectively. In this case, adjustment can be performed in such a way that the positional relation between the optical coupling member 3 and the optical device 4 is within the predetermined error range. According to this, mounting accuracy between the optical coupling member 3 and the optical device 4 can be simply improved.

In the manufacturing method, the position of the optical device 4 is adjusted in such a way that the outer edges 31a are positioned within the outer edges 44a and 45a when the main body 30 is recognized from the second face 3b. In this case, adjustment can be more securely performed in such a way that the electrodes 31 and the electrodes 44 and 45 are in the predetermined positional relations, respectively.

In the manufacturing method, the position of the optical device 4 is adjusted in such a way that the distances between the outer edges 31a and the outer edges 44a and 45a are approximately uniform in the periphery of the outer edges 31a, respectively. In this case, adjustment can be further securely performed in such a way that the electrodes 31 and the electrodes 44 and 45 are in the predetermined positional relations, respectively.

In the manufacturing method, the position of the optical device 4 may be adjusted in such a way that the center C of the light-emitting region 43 coincides with the center axis L of the hole 34. In this case, adjustment can be performed in such a way that the positional relation between the optical coupling member 3 and the optical device 4 is within the predetermined error range. According to this, mounting accuracy between the optical coupling member 3 and the optical device 4 can be simply improved.

In the manufacturing method, the position of the optical device 4 may be adjusted in such a way that the first marker 33 and the second marker 47 are in the predetermined positional relation or in such a way that the mechanical pad 32 and the mechanical pad 46 are in the predetermined positional relation when the main body 30 is recognized from the second face 3b. In this case, adjustment can be performed in such a way that the positional relation between the optical coupling member 3 and the optical device 4 is within the predetermined error range. According to this, mounting accuracy between the optical coupling member 3 and the optical device 4 can be simply improved.

In the manufacturing method, the main body 30 may be recognized from the second face 3b, and the position of the optical device 4 may be adjusted in such a way that the outer edge 33a is positioned inward of the outer edge 47a. In this case, adjustment can be more securely performed in such a way that the first marker 33 and the second marker 47 are in the predetermined positional relation.

In the manufacturing method, the electrodes 31 or the first markers 33 are provided in such a way as to protrude or to be recessed from the first face 3a, and the electrodes 44 and 45 or the second markers 47 are provided in such a way as to protrude or to be recessed from the surface 42a of the optical device 4. When the electrodes 31 or the first markers 33 are provided in such a way as to protrude from the first face 3a and the electrodes 44 and 45 or the second markers 47 are provided in such a way as to protrude from the surface, the electrodes 31 or the first markers 33, and the electrodes 44 and 45 or the second markers 47 can be simply provided. In the case where the electrodes 31 or the first markers 33 are provided in such a way as to be recessed from the first face 3a and the electrodes 44 and 45 or the second markers 47 are provided in such a way as to be recessed from the surface 42a, when the positional relation between the optical coupling member 3 and the optical device 4 is adjusted, the electrodes 31 and the electrodes 44 and 45, or the first markers 33 and the second markers 47 are prevented from interfering with each other.

In the manufacturing method, the position of the optical device 4 is adjusted in the state where the shortest clearance between the optical coupling member 3 and the optical device 4 is 10 μm or more and 1 mm or less. In this case, the positional relation between the optical coupling member 3 and the optical device 4 is adjusted in the state where the clearance between both is short, and both are joined together. Therefore, the amount of movement of the optical device 4 can be reduced when the optical coupling member 3 and the optical device 4 are joined together. Thereby, mounting accuracy between the optical coupling member 3 and the optical device 4 is improved.

In the manufacturing method, the manufacturing method of the optical module 1 includes the step of inserting optical fibers into the holes 34 of the optical coupling member 3. In this case, the optical module 1 that includes the optical fibers 5 can be manufactured.

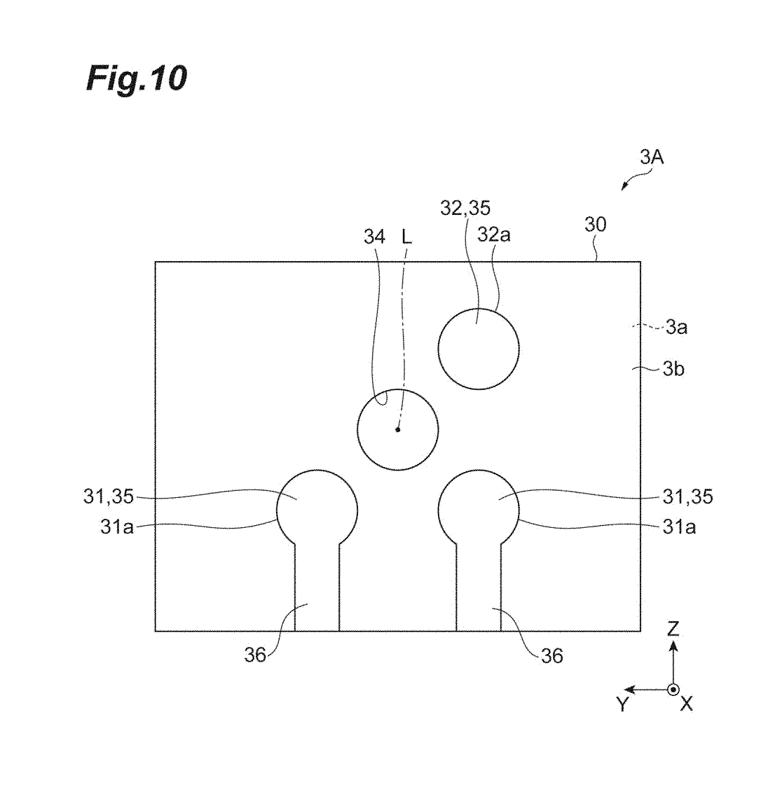

Herein, modifications of the optical coupling member 3 and the optical device 4 are described with reference to FIG. 10 to FIG. 21.

### First Modification

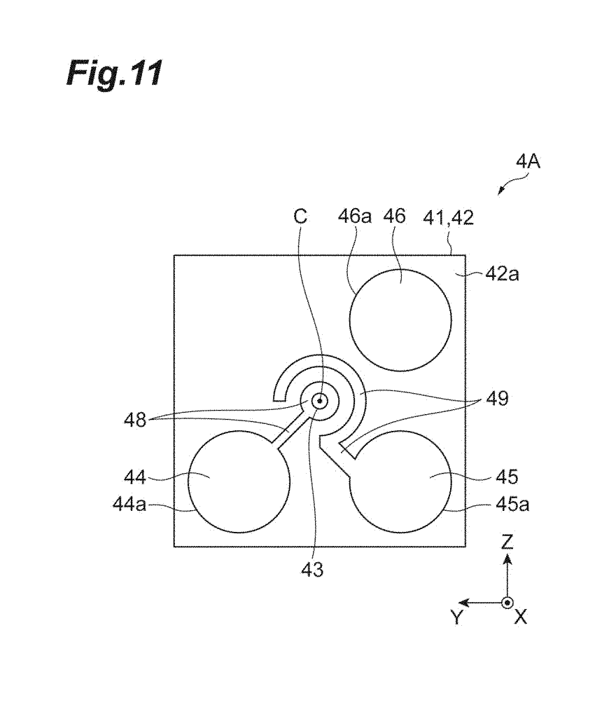

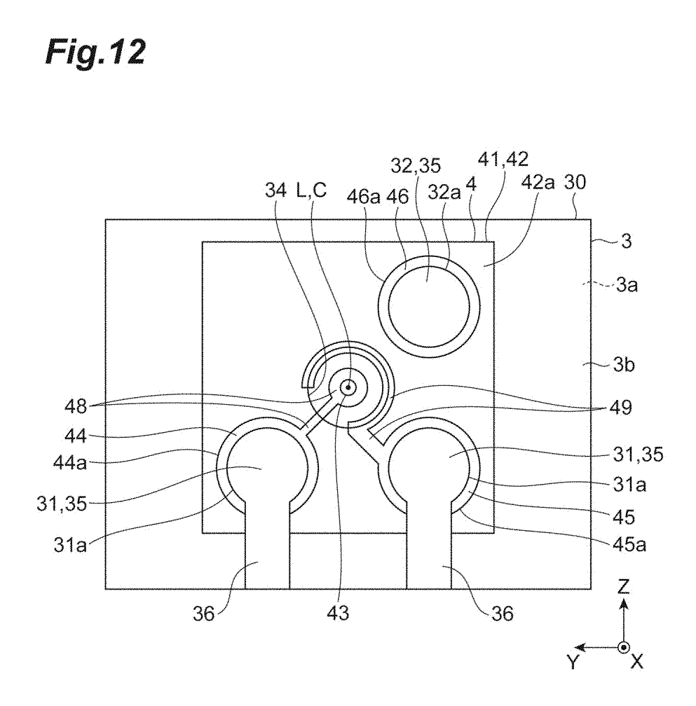

As shown in FIG. 10 and FIG. 11, an optical coupling member 3A of does not include the first markers 33, and an optical device 4A does not include the second markers 47. In the first modification, as shown in FIG. 12, a positional relation between the optical coupling member 3A and the optical device 4A is adjusted by adjusting positional relations between the electrodes 31 and the electrodes 44 and 45, a positional relation between the mechanical pad 32 and the mechanical pad 46, or a positional relation between the center axis L of the hole 34 and the center C of the light-emitting region 43.

### Second Modification

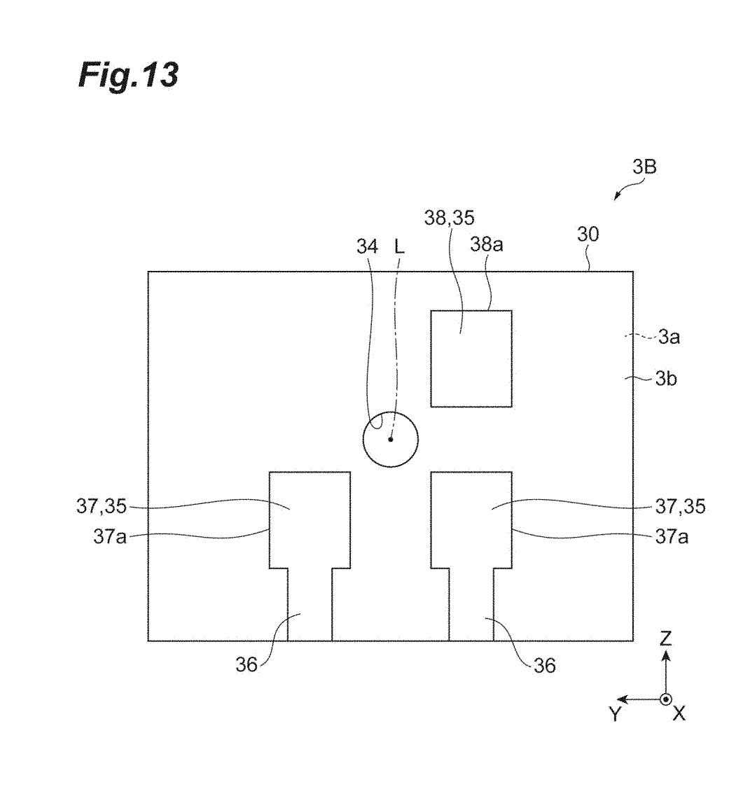

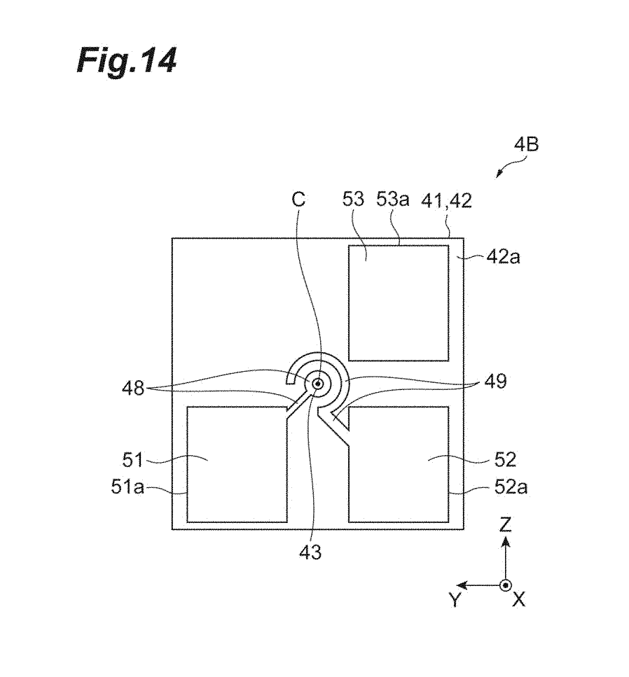

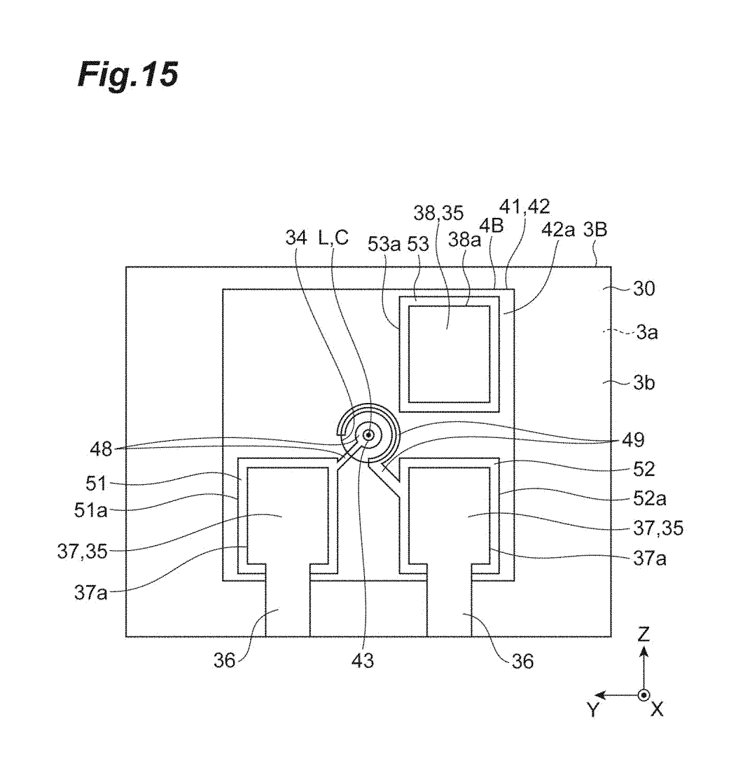

As shown in FIG. 13, an optical coupling member 3B may have electrodes 37 and a mechanical pad 38 in place of the electrodes 31 and the mechanical pad 32. The electrodes 37 and the mechanical pad 38 each have rectangular shapes. As shown in FIG. 14, an optical device 4B may have electrodes 51 and 52 and a mechanical pad 53 in place of the electrodes 44 and 45 and the mechanical pad 46. The electrodes 51 and 52 and the mechanical pad 53 each have rectangular shapes. As shown in FIG. 15, a positional relation between the optical coupling member 3B and the optical device 4B is adjusted by adjusting positional relations between the electrodes 37 and the electrodes 51 and 52, or a positional relation between the mechanical pad 38 and the mechanical pad 53.

### Third Modification

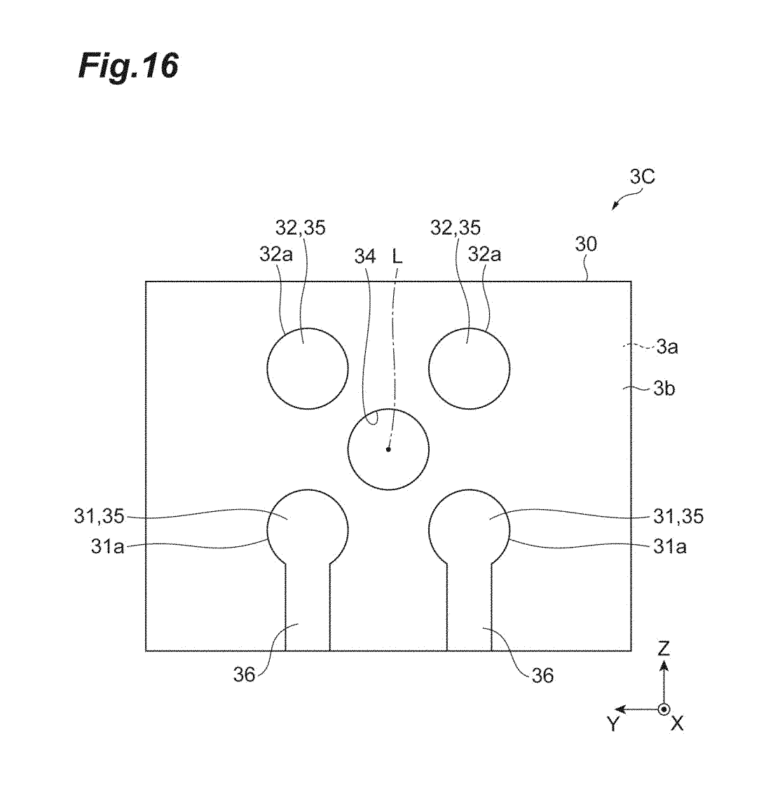

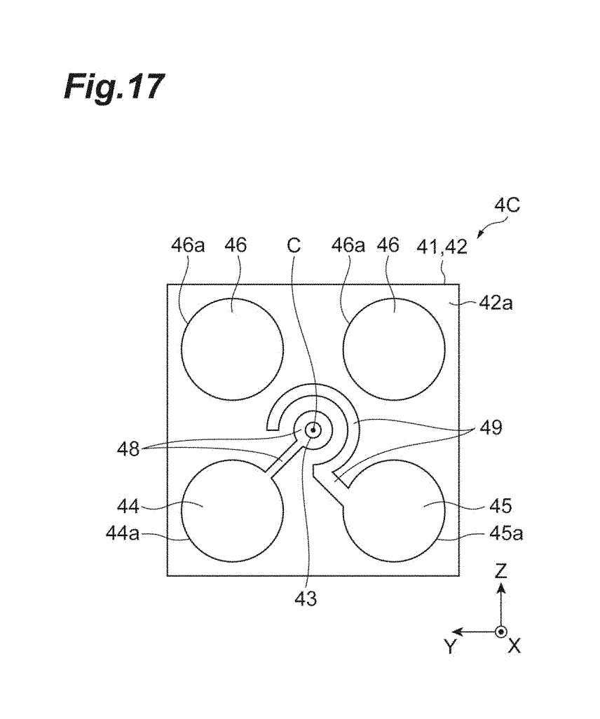

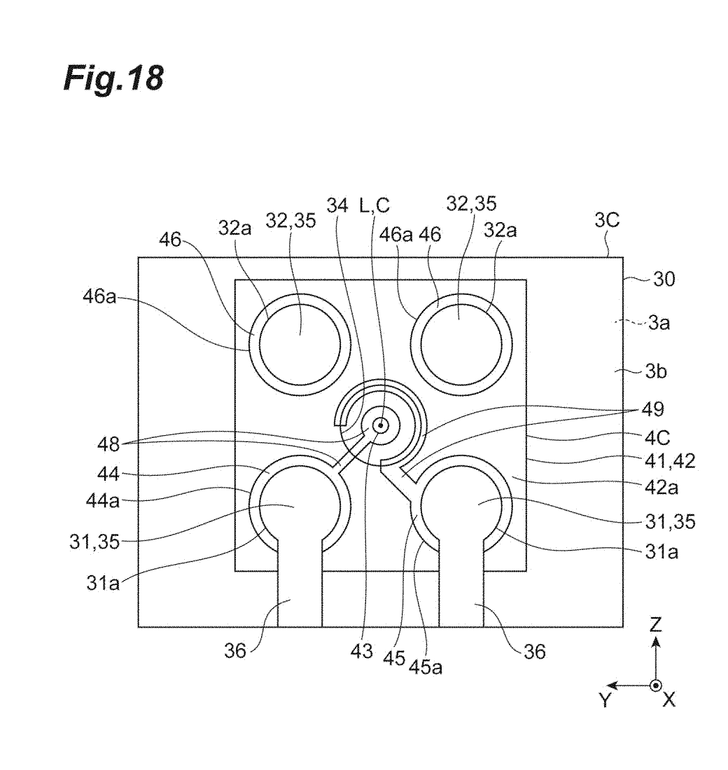

As shown in FIG. 16 and FIG. 17, an optical coupling member 3C may have two mechanical pads 32, and an optical device 4C may have two mechanical pads 46. In the third modification, as shown in FIG. 18, a positional relation between the optical coupling member 3C and the optical device 4C is adjusted by adjusting positional relations between the mechanical pads 32 and the mechanical pads 46.

### Fourth Modification

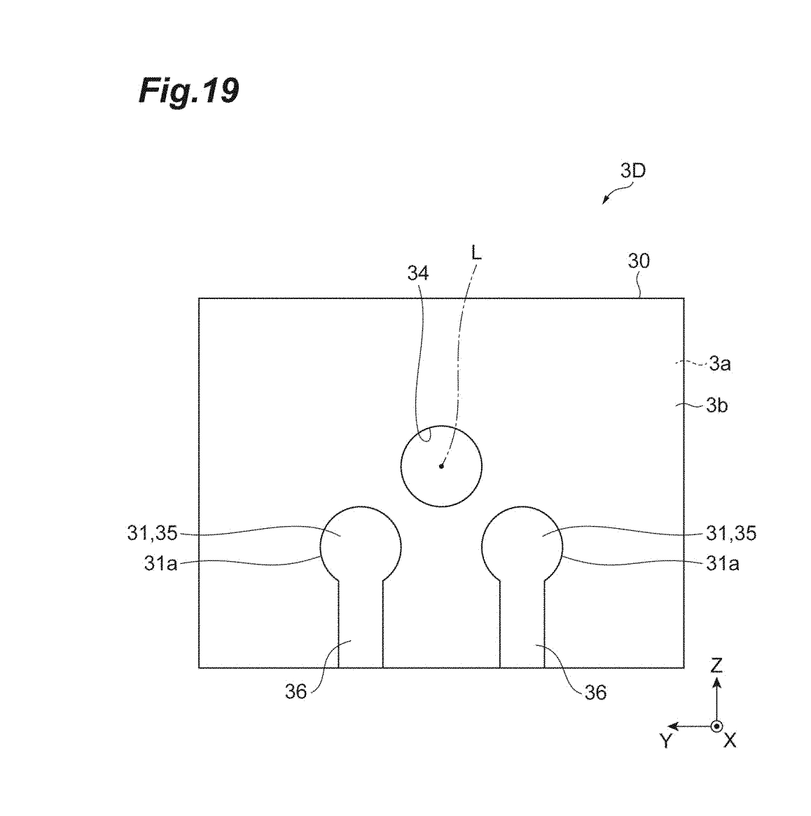

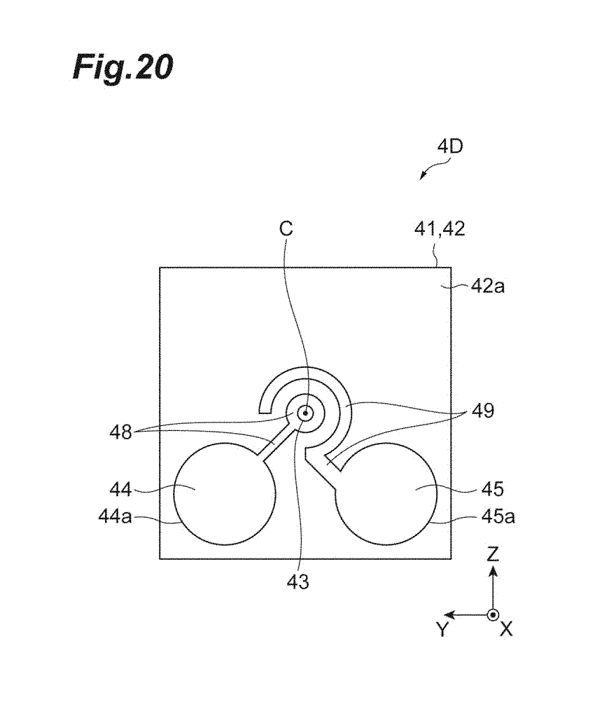

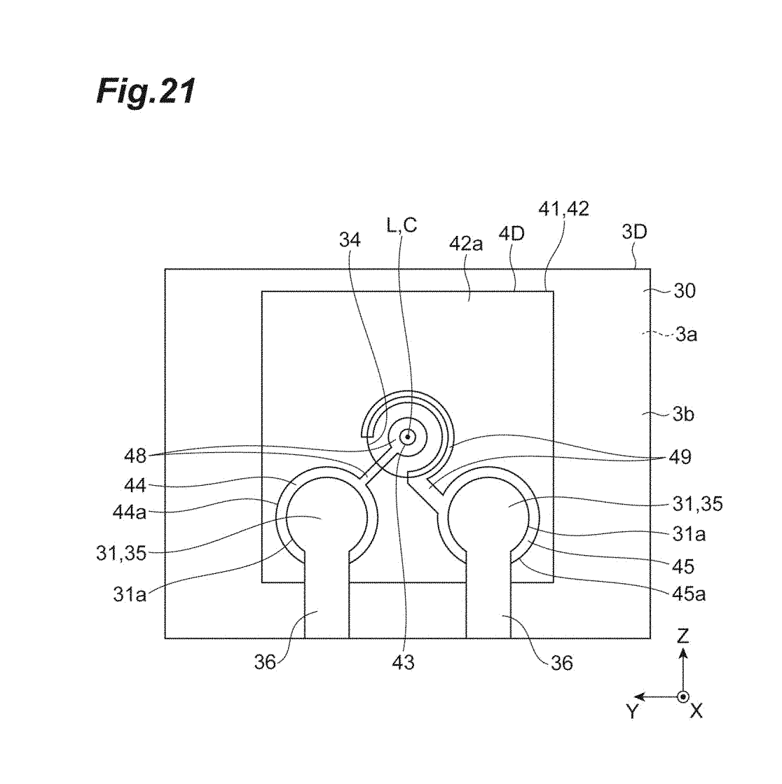

As shown in FIG. 19 and FIG. 20, an optical coupling member 3D does not include neither the mechanical pad 32 nor the first markers 33, and an optical device 4D does not include neither the mechanical pad 46 nor the second markers 47. In the fourth modification, as shown in FIG. 21, a positional relation between the optical coupling member 3D and the optical device 4D is adjusted by adjusting positional relations between the electrodes 31 and the electrodes 44 and 45.

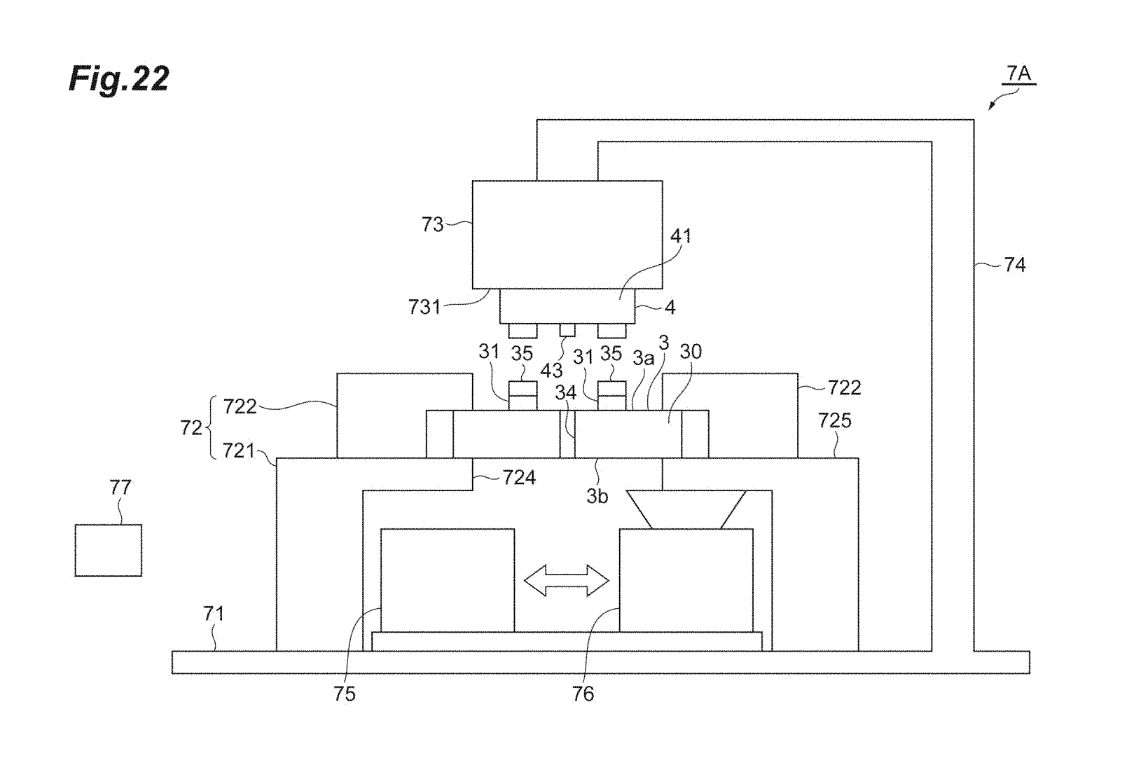

While an embodiment of the present invention has been described as above, the present invention is not limited to the aforementioned embodiment but may be modified without departing from the spirit of the present invention. For example, as shown in FIG. 22, in the manufacturing apparatus 7A of the optical module 1, the second support mechanism 73 may be supported by the hanging member 74. In this case, the image recognition device 75 and the joining device 76 are arranged on the base 71 in such a way as to face the through hole 724.

Moreover, in the manufacturing apparatus 7 or 7A, the adjustment device 77 may adjust the position of the first support mechanism 72, or may adjust the positions of both the first support mechanism 72 and the second support mechanism 73. In other words, the adjustment device 77 adjusts the position of at least one of the first support mechanism 72 and the second support mechanism 73.

Moreover, in the manufacturing method of the optical module 1, the position of the optical coupling member 3 may be adjusted in the fourth step. Moreover, the positions of both the optical coupling member 3 and the optical device 4 may be adjusted in the fourth step. In other words, the position of at least one of the optical coupling member 3 and the optical device 4 is adjusted in the fourth step. In the above embodiment, an example in which the entirety of the optical coupling member 3 is formed from a visible light-transmissive material is described, as long as the aforementioned positional adjustment can be performed, a part of the optical coupling member 3 may be formed from the visible light-transmissive material, and the other part thereof may be formed from another material.

Here, mounting accuracy in the case where the optical module 1 was produced by the aforementioned manufacturing method is described as compared with mounting accuracy in the case of using a mirror as in the conventional one. First, an optical coupling member with the configuration shown in FIG. 7 was prepared. In this optical coupling member, an insertion hole for an optical fiber, electrodes, and AuSn solder were formed, and its main body was formed from a visible light-transmissive material. Moreover, a light-emitting device (VCSEL) shown in FIG. 8 was prepared.

First, the optical device was mounted on the optical coupling member using a typical flip-chip bonding machine. In this flip-chip bonding machine, positioning is performed while recognizing the surface of the optical coupling member and the surface of the light-emitting device by a CCD camera using a mirror. In this case, mounting accuracy of the optical device relative to the optical coupling member was 5.7 μm.

Meanwhile, using the apparatus 7 shown in FIG. 5, the optical device was mounted on the optical coupling member. In this case, the mounting accuracy of the optical device relative to the optical coupling member was significantly improved, being 0.8 μm. The “mounting accuracy” stated herein is the distance between the center axis L of the hole 34 and the center C of the light-receiving/emitting region 43. As above, in accordance with the manufacturing method according to the present embodiment, it could have been investigated to be able to produce an optical module in which mounting accuracy was enhanced.

1: A method for manufacturing an optical module, comprising:
providing an optical coupling member comprising a main body and a first electrode provided on a first face of the main body, wherein the main body at least partially includes a transparent portion to visible light;
providing an optical device comprising a surface, a second electrode, and an optical region having at least one of a light-emitting region and a light-receiving region, wherein the second electrode and the optical region are provided on the surface;
arranging the optical coupling member and the optical device so as to face the first face and the surface with each other;
adjusting a position of at least one of the optical coupling member and the optical device so that a positional relation between the first face and the surface is within a predetermined range, while recognizing at least part of the first face and the surface through the transparent portion from a second face opposite to the first face in the main body; and
joining the second electrode to the first electrode.

2: The method according to claim 1, wherein the position of at least one of the optical coupling member and the optical device is adjusted so that the first electrode and the second electrode are in a predetermined positional relation.

3: The method according to claim 2, wherein the position of at least one of the optical coupling member and the optical device is adjusted so that an outer edge of the first electrode is positioned inward of an outer edge of the second electrode in the case of recognizing the main body from the second face.

4: The method according to claim 1,
wherein the optical coupling member further comprises a first marker or a first dummy electrode provided on the first face, and the optical device further comprises a second marker or a second dummy electrode provided on the surface, and
wherein the position of at least one of the optical coupling member and the optical device is adjusted so that the first marker and the second marker are in a predetermined positional relation or so that the first dummy electrode and the second dummy electrode are in a predetermined positional relation, in the case of recognizing the main body from the second face.

5: The method according to claim 4,
wherein an outer edge of the first marker and an outer edge of the second marker have similar shapes to each other, and
wherein the position of at least one of the optical coupling member and the optical device is adjusted so that the outer edge of the first marker is positioned inward of the outer edge of the second marker while recognizing the main body from the second face.

6: The method according to claim 4, wherein the first electrode or the first marker is provided in so as to protrude or to be recessed from the first face, and the second electrode or the second marker is provided so as to protrude or to be recessed from the surface.

7: The method according to claim 1, wherein the position of at least one of the optical coupling member and the optical device is adjusted so that a shortest clearance between the optical coupling member and the optical device is 10 μm or more and 1 mm or less.

8: The method according to claim 1, further comprising inserting an optical fiber into a through hole of the optical coupling member, wherein the through hole extends from the second face toward the first face and includes a center axis intersecting the first face.

9: The method according to claim 8, wherein the optical fiber is inserted after adjusting the position, and the position of at least one of the optical coupling member and the optical device is adjusted so that a center of the optical region coincides with the center axis of the through hole.

10: The method according to claim 1, wherein the main body is substantially made of a transparent material to visible light.

11: The method according to claim 1, wherein the main body is made of quartz glass, transparent thermoplastic resins, or transparent thermosetting resins.

12: A apparatus for manufacturing an optical module, comprising:
a first support mechanism configured to support an optical coupling member comprising a main body and a first electrode provided on a first face of the main body, wherein the main body at least partially includes a transparent portion to visible light;
a second support mechanism configured to support an optical device comprising a surface, a second electrode, and an optical region having at least one of a light-emitting region and a light-receiving region, wherein the second electrode and the optical region are provided on the surface;
an image recognition device configured to recognize the optical device through the transparent portion of the main body from a second face thereof opposite to the first face;
an adjustment device configured to adjust a position of at least one of the first support mechanism and the second support mechanism; and
a joining device configured to join the second electrode to the first electrode,
wherein the adjustment device adjusts the position of at least one of the optical coupling member and the optical device so that a positional relation of the optical device relative to the main body is within a predetermined range by the image recognition device.

13: An optical module comprising:
an optical coupling member comprising a main body and a first electrode provided on a first face of the main body, the main body providing therein a hole extending toward the first face from a second face opposite to the first face and the hole having a center axis intersecting the first face, wherein the main body at least partially includes a transparent portion to visible light; and
an optical device comprising a surface, a second electrode, and an optical region including at least one of a light-emitting region and a light-receiving region, the second electrode and the optical region being provided on the surface, wherein the second electrode is joined to the first electrode so that the surface faces the first face and the center axis of the hole is positioned at a center of the optical region.

14: The optical module according to claim 13, wherein an outer edge of the second electrode is larger than an outer edge of the first electrode.
